(19) United States
(12) Patent Application Publication
(10) Pub. No.: US 2008/0283704 A1
(43) Pub. Date: Nov. 20, 2008

(54) Angle Adjustable Stopwatch Supporter

(76) Inventor: Shih-Hung HSU, Taichung Hsien (TW)

Correspondence Address: Dr. BANGER SHIA, 102 Lindencrest Ct., Sugar Land, TX, 77479-5201, US

(21) Appl. No.: 12/185,080

(22) Filed: Aug. 2, 2008

Related U.S. Application Data
(63) Continuation-in-part of application No. 11/676,290, filed on Feb. 17, 2007.

(51) Int. Cl. G09F 7/18

(52) U.S. Cl. 248/230.5

(57) ABSTRACT

An angle adjustable stopwatch supporter comprises a fastening seat, a fixed seat, a sleeve and an end cap. The fixed shaft is utilized to position the sleeve and the end cap on the fastening seat. Each end of the sleeve is formed with an arc structure; likewise, the fastening seat and the end cap are formed with an arc structure respectively. In such a manner that the arc structures at both ends of the sleeve are engaged with the arc structures of the fastening seat and the end cap respectively, thus achieving the objective that the axial displacement angle can be adjusted between the fastening seat and the end cap.

This application is a continuation of part of U.S. patent application Ser. No. 11/676,290 which claims the benefit of the earlier filing date of Feb. 17, 2007. Claim 1 of this application is new, claims 2-10 of this application corresponds to the previous claims 2-9 and 11 of the U.S. patent application Ser. No. 11/676,290, respectively.

### BACKGROUND OF THE INVENTION

1. Field of the Invention

The present invention relates to a stopwatch supporter, and more particularly to an angle adjustable stopwatch supporter.

2. Description of the Prior Art

Conventionally, an alarm bell was mounted on the handlebar of a bicycle for safety; afterwards, with the development of the bicycle, a derailleur was mounted on the handlebar in order to change the chain ring according to the road conditions. Up to the present, the players of the bike competition have found that there is no enough time to notice the time on the wristwatch during riding, so a stopwatch is considered to mount on the bicycle to facilitate the riders to notice the time during the racing or training, thus controlling the speed.

Accordingly, referring to FIG. 1, a conventional stopwatch supporter for a bicycle developed on the market comprises a fastening seat 10, a fixed shaft 11, a sleeve 12 and an end cap 13. The fastening seat 10 is positioned on the handlebar of the bicycle, one end of the fixed shaft 11 which is inserted into the fastening seat 10 is also inserted through the sleeve 12 to assemble with the end cap 13, thus positioning the sleeve 12 between the fastening seat 10 and the end cap 13. In such a manner, a stopwatch can be mounted on the sleeve 12, in order that the players can notice the time during the racing.

The conventional stopwatch supporter appears to be convenient, however, it will have the shortcomings when assembled with the stopwatch. Since outer surface of the stopwatch is flat and smooth, when the players pass the road section where the sun is shining, the surface of the stopwatch will reflect the light. The players will wear sunglasses to avoid the glare of the reflected sunlight, but they can not see what is shown on the stopwatch distinctly. Surely, the player can rotate the angle of the stopwatch mounted on the stopwatch supporter, but it will cause the surface of the stopwatch to be out of the line of sight. So it is still difficult for the players to see what is shown on the stopwatch distinctly. Consequently, rotating the stopwatch is just a stopgap method; and finding out a method to solve the reflection problem absolutely is the permanent cure.

The present invention has arisen to mitigate and/or obviate the afore-described disadvantages.

### SUMMARY OF THE INVENTION

An angle adjustable stopwatch supporter in accordance with the present invention is provided for achieving the objective that the axial displacement angle of a sleeve can be adjusted between a fastening seat and an end cap by engaging two arc structures at both ends of the sleeve with an arc structure of the fastening seat and an arc structure of the end cap, respectively.

In order to achieve the above objectives, the angle adjustable stopwatch supporter in accordance with the present invention comprises a fastening seat, a fixed shaft, a sleeve and an end cap. The fastening seat is assembled on a handlebar of a bicycle; the fixed shaft is inserted through the fastening seat and the sleeve and assembled with the end cap to position the sleeve between the fastening seat and the end cap. One end of the sleeve is disposed in a recess of the fastening seat. An inner diameter of the recess of the fastening seat is greater than the outer diameter of the sleeve, thus causing a clearance therebetween. An inner diameter of the sleeve is greater than an outer diameter of the fixed shaft, thus causing a clearance therebetween. The inner diameter of the sleeve is greater than the outer diameter of the end cap, thus causing a clearance therebetween. Each end of the sleeve is formed with an arc structure, the fastening seat and the end cap are formed with an arc structure respectively. Moreover, the arc structures at both ends of the sleeve are engaged with and slide relative to the arc structure of the fastening seat and the arc structure of the end cap respectively, in such a manner that the axial displacement angle of the sleeve between the fastening seat and the end cap can be adjusted, thus adjusting the angle of the stopwatch mounted on the sleeve. Consequently, though in the reflection condition, what is shown on the stopwatch still can be seen distinctly.

In addition, the arc structure at one end of the sleeve can be an outwards protruded arc surface, while the arc structure of the fastening seat is a concave arc surface. Otherwise, the arc structure at one end of the sleeve is an inwards concave arc surface, while the arc structure of the fastening seat is a protruded arc surface.

Moreover, the arc structure at the other end of the sleeve can be an outwards protruded arc surface, while the arc structure of the end cap is a concave arc surface; otherwise, the arc structure at the other end of the sleeve is an inwards concave arc surface, while the arc structure of the end cap is a protruded arc surface.

### BRIEF DESCRIPTION OF THE DRAWINGS

FIG. 1 is an exploded view of a conventional stopwatch supporter;

FIG. 2 shows that an angle adjustable stopwatch supporter assembled with a stopwatch in accordance with the prevent invention is assembled on a handlebar of a bicycle;

FIG. 3 is an exploded view of the angle adjustable stopwatch supporter in accordance with the prevent invention;

FIG. 4 is a cross sectional view of the angle adjustable stopwatch supporter in accordance with the prevent invention;

FIG. 5 is a cross sectional view of a sleeve adjusted at an angle in accordance with the prevent invention; and

FIG. 6 is an exploded view showing that a fastening seat is integral with a fixed seat in accordance with the present invention.

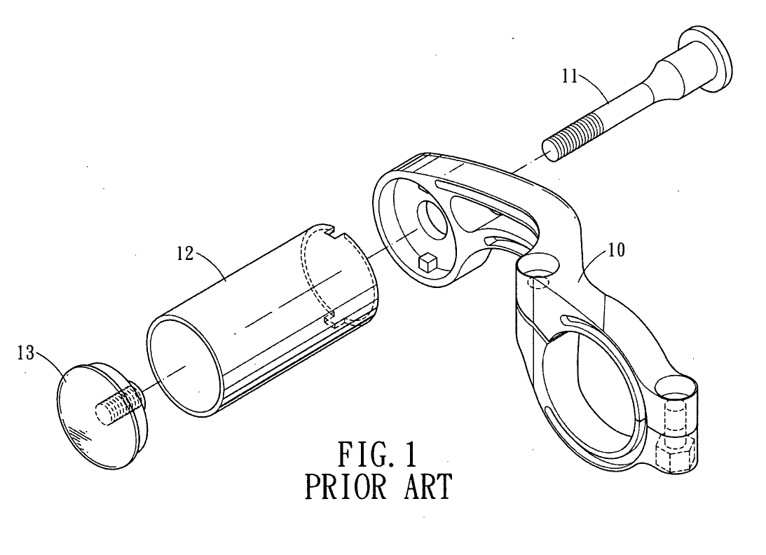

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

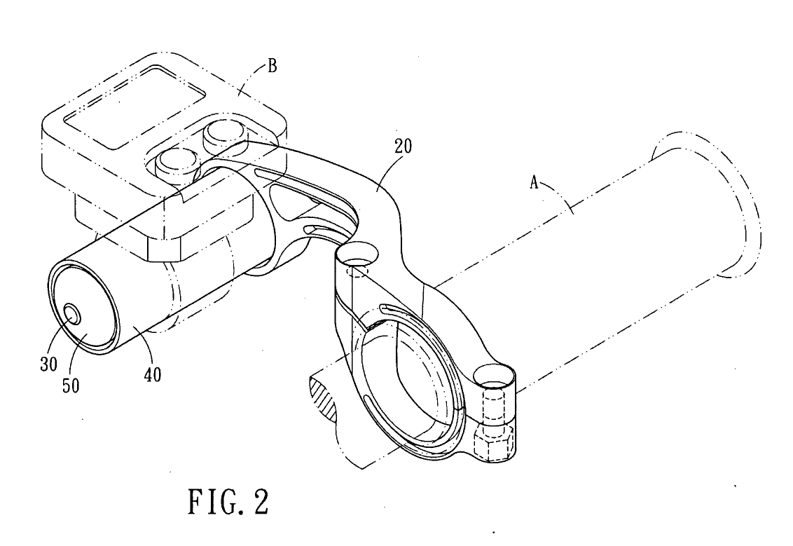

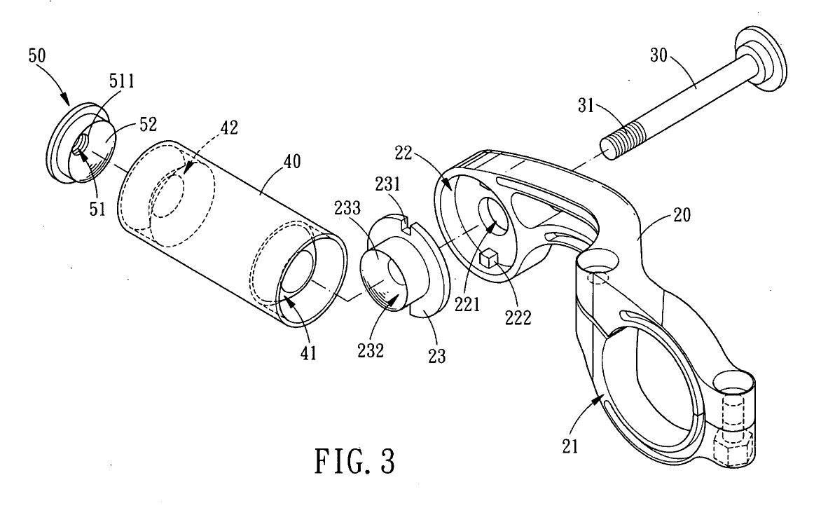

Referring to FIGS. 2-3, an angle adjustable stopwatch supporter assembled on a handlebar A of a bicycle in accordance with a preferred embodiment of the present invention comprises a fastening seat 20, a fixed shaft 30, a sleeve 40 and an end cap 50.

The fastening seat 20 is provided with a fastener 21 on one end thereof and a recess 22 in the other end thereof. The fastening seat 20 can be positioned on the handlebar A of the bicycle by the engagement of the fastener 21, in the bottom of the recess 22 is defined a through hole 221, and two opposite protuberant blocks 222 are formed on the inner surface of the recess 22. The fastening seat 20 further includes a fixed seat 23 disposed in the recess 22, and the fixed seat 23 is formed with two gaps 231 to be engaged with the protuberant blocks 222, a through hole 232 aligned with the through hole 221, and an arc structure 233.

The fixed shaft 30 has one end inserted through the through holes 221, 232 of the fastening seat 20 and the fixed seat 23, and on the outer surface of this end of the fixed shaft 30 are formed outer threads 31.

The end of the fixed shaft 30 with the outer threads 31 is inserted through the sleeve 40. The inner diameter of the sleeve 40 is greater than the outer diameter of the fixed shaft 30, thus causing a clearance between the sleeve 40 and the fixed shaft 30. One end of the sleeve 40 is disposed in the recess 22 of the fastening seat 20 and formed with a first arc structure 41. Additionally, the inner diameter of the recess 22 is greater than the outer diameter of the sleeve 40, thus causing a clearance between the recess 22 and the sleeve 40. The sleeve 40 is further formed with a second arc structure 42 at the other end thereof. The first arc structure 41 of the sleeve 40 is engaged with the arc structure 233 of the fixed seat 23 on the fastening seat 20. A stopwatch B is fastened on the outer surface of the sleeve 40.

The end cap 50 is formed with a through hole 51 having inner threads 511. The end cap 50 is screwed on the fixed shaft 30 by the cooperation of the inner threads 511 and the outer threads 31, so as to position the sleeve 40 between the fastening seat 20 and the end cap 50. The end cap 50 is disposed in the sleeve 40, and the inner diameter of the sleeve 40 is greater than the outer diameter of the end cap 50, thus causing a clearance between the sleeve 40 and the end cap 50. The end cap 50 is formed with an arc structure 52, and the end cap 50 is positioned against the second arc structure 42 of the sleeve 40 by the arc structure 52.

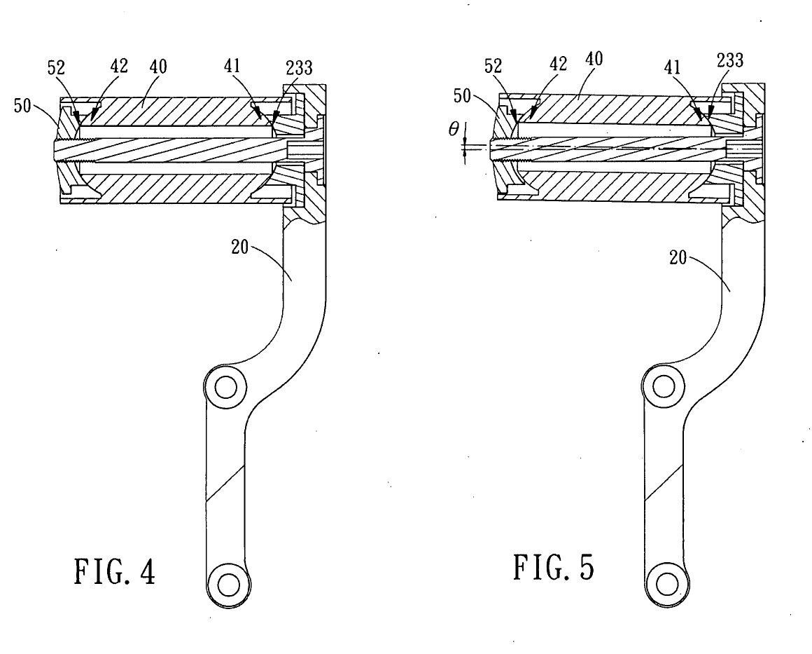

The angle adjustable stopwatch supporter in accordance with the present invention in normal state is as shown in FIG. 4, since the sleeve 40 utilizes the first arc structure 41 and the second arc structure 42 to position against and match with the arc structure 233 of the fixed seat 23 and the arc structure 52 of the end cap 50, respectively, the sleeve 40 can utilize the first arc structure 41 to slide relative to the arc structure 233 of the fixed seat 23, and the second arc structure 42 of the sleeve 40 to slide relative to the arc structure 52 of the end cap 50, respectively. Therefore, one end of the sleeve 40 can move relative to the recess 22 of the fastening seat 20, the sleeve 40 can swing relative to the fixed shaft 30, and the other end of the sleeve 40 can move relive to the end cap 50. As a result, a shown in FIG. 5, when the axial displacement angle θ of the sleeve 40 positioned between the fastening seat 20 and the end cap 50 is adjusted, the angle of the stopwatch B will be adjusted, so that the players can see what is shown on the stopwatch B distinctly without the influence of the reflected sunlight.

As for the angle adjustable stopwatch supporter in the preferred embodiment in accordance with the present invention, the first arc structure 41 of the sleeve 40 is an outwards protruded arc surface; the arc structure 233 of the fixed seat 23 is a concave arc surface. Alternatively, the first arc structure 41 of the sleeve 40 can be a concave arc surface, and the arc structure 233 of the fixed seat 23 can be an outwards protruded arc surface.

Additionally, the second arc structure 41 of the sleeve 40 in accordance the preferred embodiment is an outwards protruded arc surface, the arc structure 52 of the end cap 50 is a concave arc surface. Alternatively, the second arc structure 41 of the sleeve 40 can be a concave arc surface; the arc structure 52 of the end cap 50 can be an outwards protruded arc surface.

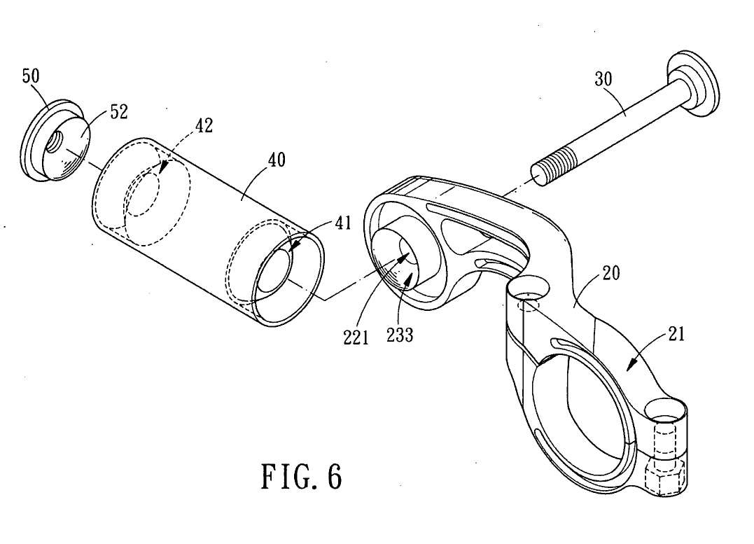

Moreover, further referring to the FIG. 6, the arc structure 233 and the through hole 221 can be directly formed in the recess 22 of the fastening seat 20, which can achieve the same function and objective.

To summarize, the angle adjustable stopwatch supporter of the present invention comprises a fastening seat, a fixed shaft, a sleeve and an end cap. The sleeve and the end cap are positioned on the fastening seat by the fixed shaft, each end of the sleeve is provide with an arc structure, likewise, the fastening seat and the end cap are formed with an arc structure respectively. The two arc structures of the sleeve are engaged with the arc structures of the fastening seat and the end cap respectively, so as to adjust the axial displacement angle between the fastening seat and the end cap.

While we have shown and described various embodiments in accordance with the present invention, it is clear to those skilled in the art that further embodiments may be made without departing from the scope of the present invention.

What is claimed is:

1. An angle adjustable stopwatch supporter comprising
a fastening seat being provided with a recess in one end thereof, the fastening seat further including an arc structure in the recess thereof, the fastening seat being assembled on a handlebar of a bicycle by the fastener;
a fixed shaft having one end inserted through the fastening seat;
a sleeve being provided for insertion of the fixed shaft, an inner diameter of the sleeve being greater than an outer diameter of the fixed shaft, thus causing a clearance therebetween, one end of the sleeve being formed with a first arc structure and disposed in the recess of the fastening seat, an inner diameter of the recess of the fastening seat being greater than an outer diameter of the sleeve, thus causing a clearance therebetween, the first arc structure of the sleeve being engaged with the arc structure of the fastening seat, the other end of the sleeve being formed with a second arc structure; and
an end cap being assembled to the fixed shaft to position the sleeve between the fastening seat and the end cap, the end cap being disposed in the sleeve, the inner diameter of the sleeve being greater than an outer diameter of the end cap, thus causing a clearance therebetween, the end cap being formed with an arc structure, the arc structure of the end cap being matched with the second arc structure of the sleeve, the first arc structure of the sleeve slides relative to the arc structure of the fastening seat, and the second structure of the sleeve slides relative to the arc structure of the end cap, so that one end of the sleeve moves relative to the recess of the fastening seat, the sleeve swings relative to the fixed shaft and the other end of the sleeve moves relative to the end cap, thus adjusting an axial displacement angle of the sleeve between the fastening seat and the end cap.

2. The angle adjustable stopwatch supporter as claimed in claim 1, wherein the first arc structure of the sleeve is an outwards protruded arc surface, the arc structure of the fastening seat is a concave arc surface.

3. The angle adjustable stopwatch supporter as claimed in claim 1, wherein the first arc structure of the sleeve is a concave arc surface, the arc structure of the fastening seat is an outwards protruded arc surface.

4. The angle adjustable stopwatch supporter as claimed in claim 1, wherein the second arc structure of the sleeve is an outwards protruded arc surface, the arc structure of the end cap is a concave arc surface.

5. The angle adjustable stopwatch supporter as claimed in claim 2, wherein the second arc structure of the sleeve is an outwards protruded arc surface, the arc structure of the end cap is a concave arc surface.

6. The angle adjustable stopwatch supporter as claimed in claim 3, wherein the second arc structure of the sleeve is an outwards protruded arc surface, the arc structure of the end cap is a concave arc surface.

7. The angle adjustable stopwatch supporter as claimed in claim 1, wherein the second arc structure of the sleeve is an inwards concave arc surface, the arc structure of the end cap is a protruded arc surface.

8. The angle adjustable stopwatch supporter as claimed in claim 2, wherein the second arc structure of the sleeve is an inwards concave arc surface, and the arc structure of the end cap is a protruded arc surface.

9. The angle adjustable stopwatch supporter as claimed in claim 3, wherein the second arc structure of the sleeve is an inwards concave arc surface, and the arc structure of the end cap is a protruded arc surface.

10. The angle adjustable stopwatch supporter as claimed in claim 1, wherein the fastening seat includes a fixed seat formed with the arc structure of the fastening seat.
